(19) United States
(12) Patent Application Publication
(10) Pub. No.: US 2025/0293961 A1
(43) Pub. Date: Sep. 18, 2025

(54) HEALTH MONITORING, AND ASSOCIATED SYSTEMS, DEVICES, UNITS, AND METHODS

(71) Applicant: LiveView Technologies, LLC, American Fork, UT (US)

(72) Inventors: Gavin Ransom, American Fork, UT (US); Previn Menon, American Fork, UT (US); Hunter Dalsing, American Fork, UT (US)

(21) Appl. No.: 19/073,902

(22) Filed: Mar. 7, 2025

Related U.S. Application Data
(60) Provisional application No. 63/566,532, filed on Mar. 18, 2024.

(51) Int. Cl. H04L 43/0817

(52) U.S. Cl. CPC H04L 43/0817

(57) ABSTRACT

Various embodiments relate to health monitoring of a number of mobile surveillance units. A system may include a mobile surveillance unit including a number of devices and a number of configuration files. Each configuration file may include a number of expected parameter values associated with one or more of the number of devices. The mobile surveillance unit may also include a health monitor unit configured to compare at least one parameter value of the number of parameter values for at least one device of the number of devices to at least one sensed parameter value of the at least one device. The mobile surveillance unit may be configured to generate at least one of a report or an alert responsive to the comparison. Associated devices and methods are also disclosed.

### CROSS-REFERENCE TO RELATED APPLICATIONS

This application claims the benefit under 35 U.S.C. § 119(e) of U.S. Provisional Patent Application Ser. No. 63/566,532, filed Mar. 18, 2024, the disclosure of which is hereby incorporated herein in its entirety by this reference.

### TECHNICAL FIELD

This disclosure relates generally to health monitoring and, more specifically, to file-based health monitoring of a remote unit, and to related systems, devices, units, and methods.

### BACKGROUND

Existing solutions for monitoring remote devices and/or systems include network-based monitoring, which requires cloud to device communication to acquire device status. Network-based monitoring further requires code changes and redeployment for any modifications (e.g., modification of areas and/or items to be monitored). Another existing solution includes edge software platform (ESP) monitoring, which also requires code changes and redeployment for any modifications. ESP monitoring may also utilize Open Telemetry (OTEL), which may negatively impact network bandwidth. These conventional solutions unnecessarily consume data (e.g., cellular data) and are expensive to maintain.

### BRIEF DESCRIPTION OF THE DRAWINGS

FIG. 1 depicts an example system including a mobile unit, in accordance with one or more embodiments of the disclosure.

FIG. 2 depicts two example configuration files, in accordance with various embodiments of the disclosure.

FIG. 3 is a block diagram illustrating an example system including a health monitor, according to various embodiments of the disclosure.

FIG. 4 depicts another example system including a mobile unit, in accordance with various embodiments of the disclosure.

FIG. 5 depicts an example system including a mobile unit, a server, and one or more devices, in accordance with various embodiments of the disclosure.

FIG. 6 illustrates another example system, according to one or more embodiments of the disclosure.

FIG. 7 is a flowchart illustrating an example method, according to various embodiments of the disclosure.

### DETAILED DESCRIPTION

Referring in general to the accompanying drawings, various embodiments of the present disclosure are illustrated to show example embodiments related to file-based health monitoring of a device, such as a unit (e.g., a mobile unit), which may be remote from another device, such as a server. It should be understood that the drawings presented are not meant to be illustrative of actual views of any particular portion of an actual circuit, device, system, or structure, but are merely representations that are employed to more clearly depict various embodiments of the disclosure.

The following provides a more detailed description of the present invention and various representative embodiments thereof. In this description, functions may be shown in block diagram form in order not to obscure the present invention in unnecessary detail. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

Embodiments of this disclosure may provide an efficient solution to add new devices to a system (e.g., a surveillance/security system), remove remote devices from the system, adjust devices, and/or to enable notification regarding the health of one or more devices of the system, based on specific criteria. Various embodiments may conserve bandwidth (e.g., use only what is needed) and may not require code changes for various events, such as adding and/or deleting devices and/or changing criteria. According to various embodiments, a messaging protocol (e.g., an industry standard, such as message queuing telemetry transport (MQTT)) optimized for bandwidth may be used in carrying out various embodiments.

Various embodiments may include a health monitoring system that stores device, application, and/or system level metrics locally (e.g., on an edge device, such as a mobile surveillance unit). The system may compare actual metrics (e.g., sensed and/or measured data) against stored data (e.g., a configuration file of criteria (e.g., including one or more metrics)) to determine if any device, application, or system is, for example, operating unexpectedly. If any metric is operating out of an expected range, details may be reported (e.g., to a cloud service) for alerting and/or further processing.

Various embodiments may provide for the ability to easily track and change health criteria/metrics based on a file (e.g., a configuration file) (i.e., rather than having to change code and re-deploy software). This may allow programmers and/or non-programmers to make changes as needed. Further, various embodiments may reduce data consumption (e.g., conserve cellular data). In at least some embodiments, a heartbeat for each edge device may be detected (e.g., by a remote server), however it may not be necessary to send other data (e.g., repetitive metric data) from an edge device to a server, for example.

In some embodiments, configuration files (e.g., including expected parameters and/or desired data) can be set, for example, on a per-unit (e.g., per mobile unit) basis. For example, it may be desirable to gather a first set of data (e.g., a relatively large amount of data) from a first mobile unit and another set of data (e.g., an amount of data much less than the amount of data of the first set of data) from a second mobile unit. Thus, in this example, configuration files for the first and second mobile units may be different and configured as desired.

As noted above, utilizing embodiments of the disclosure, code changes and/or code redeployment may not be required to modify or add criteria and/or parameters (e.g., what to monitor, when to monitor, how often to monitor, what values are set (e.g., for health comparisons (e.g., what are acceptable (e.g., operating) values, such as temp, voltage, current, etc.)), and what data is requested, without limitation). Rather, the configuration file, which may exist on an edge device (e.g., one a remote (e.g., mobile) unit), may be updated with any changes or requirements (i.e., to criteria, parameters, parameter values, etc.) (e.g., depending on what, and how much, data is desired). Thus, monitoring (e.g., comparing a measured value against a configuration file value (e.g., an expected (or acceptable) value)) may be performed with little to no communication between a device (e.g., an edge device, such as a mobile unit) and a remote device (e.g., a server, such as a cloud server).

As will be appreciated, various embodiments of the disclosure, as described more fully herein, provide a technical solution to one or more problems that arise from technology that could not reasonably be performed by a person, and various embodiments disclosed herein are rooted in computer technology in order to overcome the problems and/or challenges described below. Further, at least some embodiments disclosed herein may improve computer-related technology by allowing computer performance of a function not previously performable by a computer. Embodiments of the disclosure will now be explained with reference to the accompanying drawings.

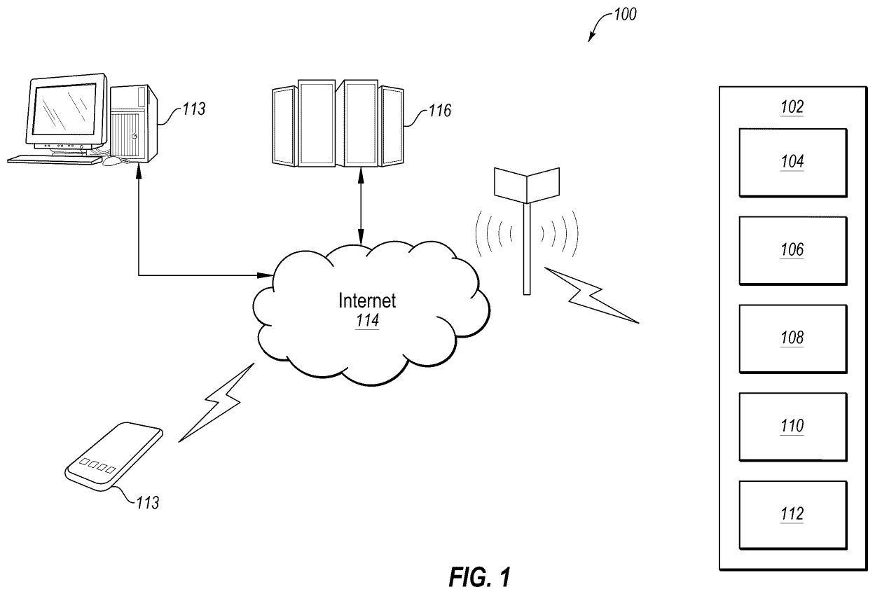

FIG. 1 illustrates a system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors 104 (e.g., cameras, weather sensors, motion sensors, noise sensors, chemical sensors, without limitation) and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., loudspeakers, two-way public address (PA) speaker systems, or any other suitable speaker), any other suitable output device (e.g., a digital display), or any combination thereof.

In some embodiments, unit 102 may also include one or more storage devices 108. Storage device 108, which may include any suitable storage device (e.g., a memory card, a solid state drive (SSD), a hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation, storage device 108 may continuously record data (e.g., video, images, i-frames, and/or other data) captured by one or more sensors 104 (e.g., cameras, lidar, radar, RF sensors, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Computer 110 may include an operating system (e.g., installed on a hard drive). Moreover, although not shown in FIG. 1, unit 102 may include one or more additional devices including, but not limited to, one or more microphones, one or more solar panels, one or more power generators (e.g., fuel cell generators), or any combination thereof. Unit 102 may also include a communication device 112, which may comprise any suitable and known communication device (e.g., a modem such as a cellular modem, a satellite modem, a Wi-Fi modem, etc.). In some embodiments, communication device 112 may include one or more radios and/or one or more antennas. As will be appreciated, components of unit 102 may be suitably coupled via wired connections, wireless connections, or a combination thereof.

System 100 may further include one or more electronic devices 113, which may comprise, for example only, a mobile device (e.g., mobile phone, tablet, etc.), a laptop computer, a desktop computer, or any other suitable electronic device including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via a network 114 (e.g., one or more metered connections, such as a cellular connection and/or a satellite connection).

According to various embodiments of the disclosure, unit 102 may be within a first location (a “camera location” or a “unit location”), and server 116 may be within a second location, remote from the first location. In addition, cach electronic device 113 may or may not be remote from unit 102 and/or server 116. As will be appreciated by a person having ordinary skill in the art, system 100 may be modular, expandable, and/or scalable.

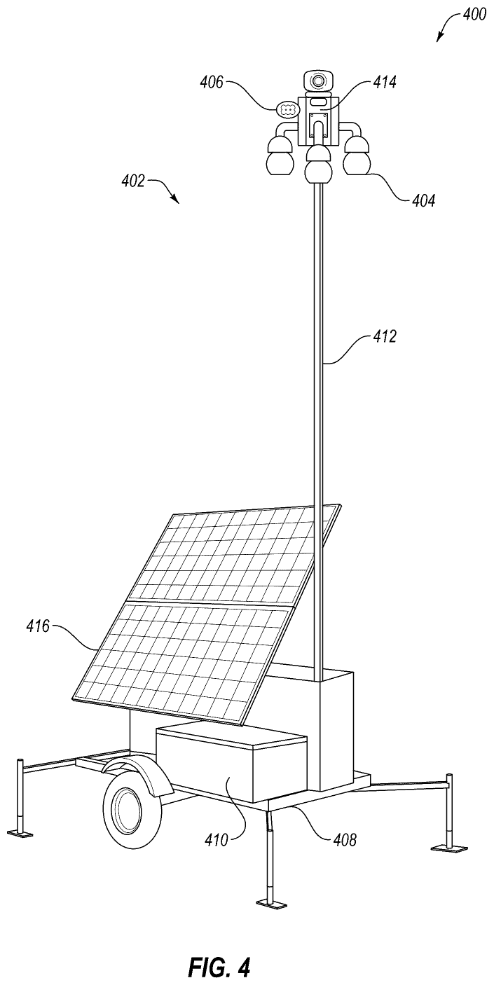

As noted above, in some embodiments, unit 102 may include a mobile unit (e.g., a mobile security/surveillance unit). In these and other embodiments, unit 102 may include a portable trailer (not shown in FIG. 1; see FIG. 4), a storage box (e.g., including one or more batteries) (not shown in FIG. 1; see FIG. 4), and a mast (not shown in FIG. 1; see FIG. 4) coupled to a head unit (e.g., including, for example, one or more cameras, one or more lights, one or more speakers, and/or one or more microphones) (not shown in FIG. 1). According to various examples, in addition to sensors and output devices, a head unit of unit 102 may include and/or be coupled to storage device 108, computer 110, and/or communication device 112. Although unit 102 is described herein as being a mobile unit, the disclosure is not so limited, and in some embodiments, unit 102 may be a fixed device (e.g., mounted to a wall (e.g., an interior or exterior wall), pole, etc.).

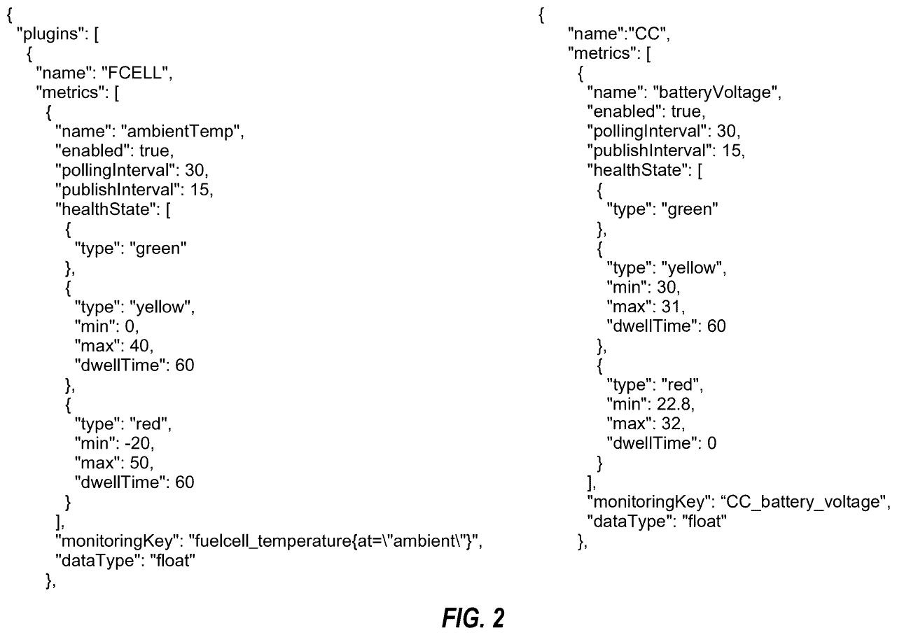

FIG. 2 depicts two example configuration files (e.g., for a fuel cell generator and a charge controller), which may be stored at a device, such as a mobile unit (e.g., mobile unit 102 of FIG. 1). For example, storage device 108 (see FIG. 1) of mobile unit 102 may store one or more configuration files. As will be appreciated, a configuration file may define one or more parameter types, associated parameter values, and possibly other data for a device. More specifically, for example, a configuration file may define one or more parameter types (e.g., battery voltage, temperature, current, etc.) and associated parameter values (i.e., expected or acceptable voltage, current, and/or temperature values), one or more intervals (e.g., a polling interval, a publishing interval, etc.), a health state (e.g., green, yellow, or red (i.e., defined by various defined values)) for a device. For example, a “polling interval” may be considered a parameter type, and a time (e.g., 30 seconds, 5 minutes, etc.) may be considered a parameter value.

For example, with reference to the left side of FIG. 2, at least a portion of a configuration file including a temperature (i.e., the parameter type) (“ambientTemp”) for a fuel cell (“FCELL”) (i.e., a device) is shown. In this example, various metric values (also referred to herein as “parameter values”) are defined, including metric values associated with a “yellow” state (e.g., for a report and/or an alert) and a “red” state (e.g., for a report and/or an alert). As another example, with reference to the right side of FIG. 2, at least a portion of a configuration file including a voltage (i.e., the parameter type) (“battery Voltage”) for a charge controller (“CC”) (i.e., a device) is shown. In this example, various metric values are defined, including metric values associated with a “yellow” state (e.g., for a report and/or an alert) and a “red” state (e.g., for a report and/or an alert). The configuration files shown in FIG. 2 are provided as examples only, and any suitable configuration file may be within the scope of the disclosure. It is noted that a device (e.g., a fuel cell or a charger) may be associated with one or more configuration files and/or a configuration file may include data for one or more devices and/or one or more parameter types.

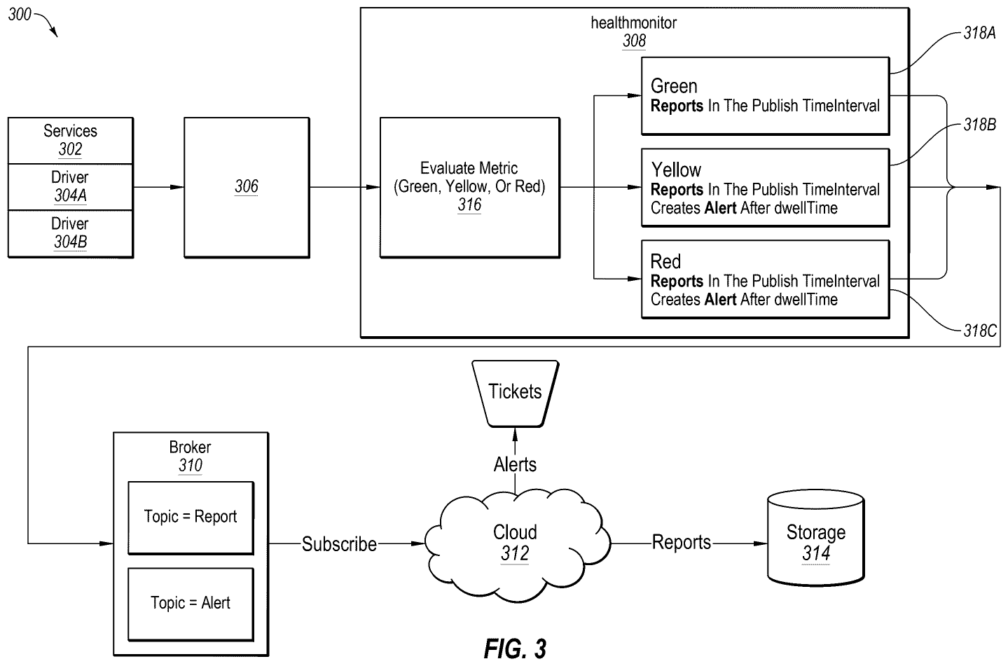

FIG. 3 depicts a system 300, according to various embodiments of the disclosure. System 300 includes services 302 (e.g., hardware services) (e.g., a fuel cell service, battery service, sensor service, without limitation), drivers 304A and 304B (e.g., a bios driver, a fuel cell driver, or any other suitable driver), and a monitoring system 306 (e.g., Prometheus or other suitable monitoring system/service). Services 302 and/or drivers 304A, 304B may provide data to monitoring system 306 (e.g., for gathering data). For example, data provided to monitoring system 306 may include values (e.g., sensed parameter values) for various parameters (e.g., current, voltage, temp, state, without limitation) associated with one or more devices (e.g., lights, cameras, I/O devices, communication devices, power generators, charger controller, fuel cell generator, and/or any other device) of a device (e.g., a mobile unit). Further, system 300 includes a health monitor 308, a broker 310, a cloud device (e.g., a cloud server) 312, and storage 314.

Example parameter types (also referred to herein as “metrics” or “metric types”) may include current, voltage, temperature associated with a device. A parameter type may include a setting associated with a device, a state of a device (e.g., is a heat trace on or off, is a fan on or off, an operational state of a device, is a charger in bulk, absorb, float, rest, equalization, etc.) or a change of state of a device. Further, a parameter type may include a time, such as runtime hours, associated with a device. In another example, a parameter type may include or identify a remaining amount of fuel (e.g., methanol or other fuel), such as a number of remaining cartridges of fuel or a specific amount of fuel remaining. Moreover, in one example, a parameter type and associated value may define how often other parameters are evaluated (e.g., every X minutes, Y days, etc.). As another example, a parameter type may define what type of data is required (e.g., to be in a report), how much data is desired, and/or any other data that may be useful regarding one or more devices (e.g., of a unit, such as a mobile surveillance unit).

Health monitor 308, which may, for example, query monitoring system 306 for data, may include an evaluation unit 316 (e.g., including a number of configuration files) (e.g., for evaluating (e.g., comparing) parameter values and generating data) and tools 318A, 318B, and 318C (e.g., for generating appropriate reports and/or alerts (e.g., green for a report, yellow and/or red for alerts)). More specifically, evaluation unit 316 may compare at least one sensed parameter value of a device to at least one expected parameter value (e.g., stored in a configuration file).

For example, tool 318A may, in response to a sensed parameter value being at a normal (e.g., expected) value or being within an acceptable range, generate a report that may or may not be published. Further, for example, tool 318B may, in response to a sensed parameter value being abnormal (e.g., an unexpected value) or being outside of, or nearly outside of, an acceptable range, generate an alert and/or a report that may or may not be published. As another example, tool 318C may, in response to a sensed parameter value being abnormal (e.g., an unexpected value) or being outside of, or nearly outside of, an acceptable range, generate an alert and/or a report that may or may not be published. For example, an alert generated by tool 318B may be different (e.g., less urgent) than an alert generated via tool 318C. As will be appreciated, tools (e.g., tools 318A, 318B, and 318C) may be configured such that various responses (e.g., alerts, reports, or other actions) may be provided based on, for example, a sensed parameter value, a measurement, a time, or other variable. As a more specific example, some events may require more urgent and/or detailed alerts/reports.

For example, broker 310 may include an MQTT broker or any other suitable broker (e.g., for coordinating messages). Further, for example, data based on an evaluation at unit 316 may be generated via tools 318A, 318B, 318C, and/or broker 310. Additionally, for example, an alert may result in a ticket (or other event) and an alert and/or a report may be stored (e.g., in storage 314) and/or published.

According to various embodiments, an edge device (e.g., including a unit, such as a mobile unit (e.g., mobile unit 102 of FIG. 1)) may include services 302, drivers 304A, 304B, monitoring system 306, and/or broker 310. Further, for example, another device, such as a cloud server, may include cloud device 312 and/or storage 314.

For example only, a contemplated operation will now be described. In this example, a voltage of a specific battery of a mobile surveillance unit may be sensed (e.g., via service 302 and/or driver 304A, 304B) and provided to monitoring system 306. Further, after querying monitoring system 306 for the sensed voltage, health monitor 308 may compare the sensed voltage to an expected (or acceptable) voltage (i.e., for the specific battery) stored in a configuration file. Based on the comparison, and possibly one or more defined criteria, a report and/or an alert may be generated. For example, in response to the sensed voltage substantially matching the expected voltage, a report may or may not be generated and sent to a device (e.g., cloud device 312) and possibly stored (e.g., in storage 314). As another example, in response to the sensed voltage being different than expected voltage (e.g., by a relatively small amount), an alert (e.g., a “yellow” alert) may be generated and sent to a device (e.g., cloud device 312) and possibly stored (e.g., in storage 314). As yet another example, in response to the sensed voltage being different than expected voltage (e.g., by a relatively large amount or for a relative long time), an alert (e.g., a “red” alert) may be generated and sent to a device (e.g., cloud device 312) and possibly stored (e.g., in storage 314).

In another example contemplated operation, an amount of fuel (i.e., for a generator of a mobile surveillance unit) remaining may be monitored (e.g., via service 302 and/or driver 304A, 304B) and provided to monitoring system 306. Further, after querying monitoring system 306 for the remaining amount of fuel, health monitor 308 may compare the remaining amount of fuel to one or more defined amount values stored in a configuration file. Based on the comparison, and possibly one or more defined criteria, a report and/or an alert may be generated. For example, in response to the remaining amount of fuel being greater than, for example, 50% (i.e., of a max amount), a report may or may not be generated and sent to a device (e.g., cloud device 312) and possibly stored (e.g., in storage 314). As another example, in response to the remaining amount of fuel being 25%-50%, an alert (e.g., a “yellow” alert) may be generated and sent to a device (e.g., cloud device 312) and possibly stored (e.g., in storage 314). As yet another example, in response to the remaining amount of fuel being less than 25%, an alert (e.g., a “red” alert) may be generated and sent to a device (e.g., cloud device 312) and possibly stored (e.g., in storage 314).

As will be appreciated, these contemplated operations are provided as examples only, and any operation in which a sensed value of a device is compared to another (i.e., stored) value to monitor a status or a state (e.g., a health status or state) of the device is within the scope of the disclosure.

FIG. 4 depicts another example system 400 including a unit 402, in accordance with various embodiments of the disclosure. Unit 402, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 402 may include one or more sensors 404 (e.g., cameras, weather sensors, motion sensors, noise sensors, without limitation) and one or more output devices 406 (e.g., lights, speakers, electronic displays, without limitation).

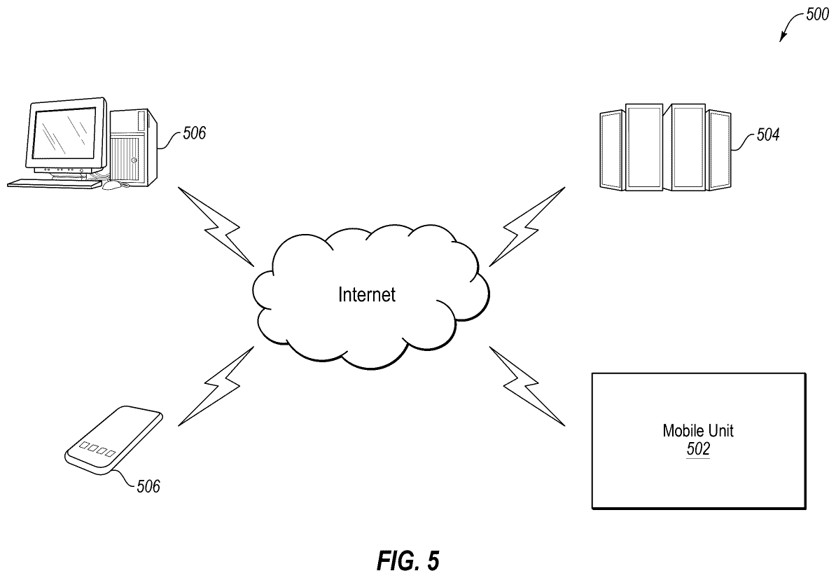

Unit 402 may also include at least one storage device (e.g., internal flash media, a network attached storage device, or any other suitable electronic storage device), which may be configured for receiving and storing data (e.g., video, images, audio, without limitation) captured by one or more sensors of unit 402. According to some embodiments, unit 402 may include unit 102 of FIG. 1 and/or a mobile unit 502 of FIG. 5.

In some embodiments, unit 402 may include a mobile unit. In these and other embodiments, unit 402 may include a portable trailer 408, a storage box 410, and a mast 412 coupled to a head unit (also referred to herein as a “live unit,” an “edge device,” or simply an “edge”) 414, which may include (or be coupled to), for example, one or more batteries, one or more cameras, one or more lights, one or more speakers, one or more microphones, and/or other input and/or output devices. According to some embodiments, a first end of mast 412 may be proximate storage box 410 and a second, opposite end of mast 412 may be proximate, and possibly adjacent, head unit 414. More specifically, in some embodiments, head unit 414 may be coupled to mast 412 at an end opposite an end of mast 412 proximate storage box 410.

In some examples, unit 402 may include one or more primary batteries (e.g., within storage box 410) and one or more secondary batteries (e.g., within head unit 414). In these embodiments, a primary battery positioned in storage box 410 may be coupled to a load and/or a secondary battery positioned within head unit 414 via, for example, a cord recl.

In some embodiments, unit 402 may also include one or more solar panels 416, which may provide power to one or more batteries of unit 402. More specifically, according to some embodiments, one or more solar panels 416 may provide power to a primary battery within storage box 410. Although not illustrated in FIG. 4, unit 402 may include one or more other power sources, such as one or more generators (e.g., fuel cell generators) (e.g., in addition to or instead of solar panels). Further, for example, unit 402 may be configured to couple to and receive power from an electrical outlet (e.g., electrical wall socket). As will be appreciated, unit 402 may include at least a portion of a monitoring system in accordance with various embodiments disclosed herein. More specifically, for example, unit 402 may include services 302, drivers 304A, 304B, monitoring system 306 (i.e., including one or more configuration files), and/or broker 310 (see FIG. 3).

FIG. 5 depicts a system 500, in accordance with various embodiments of the disclosure. System 500 includes mobile unit 502 (e.g., unit 402 of FIG. 4), a server 504, and one or more electronic devices 506 (e.g., coupled to one another via a network (e.g., cellular network, satellite network, any other suitable communication network, or any combination thereof). In one non-limiting example, mobile unit 502 includes mobile unit 502 (e.g., unit 402; see FIG. 4), server 504 may include a cloud server or any other server, and electronic device(s) 506 may include an electronic device, such as a front-end device (e.g., a user device (e.g., mobile phone, tablet, etc.), a desktop computer, or any other suitable electronic device (e.g., including a display)). According to various embodiments, each of server 504 and electronic device(s) 506 may be remote from mobile unit 502. Further, for example, server 504 may include a cloud-based processor. In at least some examples, mobile unit 502 may include unit 402 of FIG. 4, and server 504 may include cloud device 312 of FIG. 3.

According to various embodiments of the disclosure, mobile unit 502, which may include a modem, may be within a first location (a “camera location” or a “remote location”), and server 504 may be within a second location, remote from the camera location. In addition, in at least some examples, electronic device 506 may be remote from the camera location and/or server 504. As will be appreciated by a person having ordinary skill in the art, system 500 may be modular, expandable, and/or scalable.

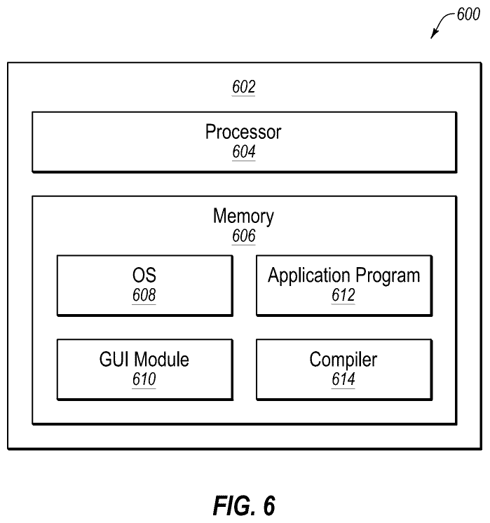

FIG. 6 illustrates a system 600 that may be used to implement embodiments of the disclosure. System 600 may include a computer 602 that comprises a processor 604 and memory 606. In some examples, computer 602 may include computer 110 of FIG. 1.

For example only, and not by way of limitation, computer 602 may include a workstation, a laptop, or a hand-held device such as a cell phone or a personal digital assistant (PDA), a server (e.g., server 116), computer 110 (see FIG. 1), or any other processor-based device known in the art. In one embodiment, computer 602 may be operably coupled to a display (not shown in FIG. 6), which presents images to the user via a GUI. As will be appreciated, computer 602 may include one or more controllers including one or more operating systems, which may be configured and/or updated in accordance with various embodiments disclosed herein.

Generally, computer 602 may operate under control of an operating system 608 stored in memory 606, and interface with a user to accept inputs and commands and to present outputs through a GUI module 610. Although GUI module 610 is depicted as a separate module, the instructions performing the GUI functions may be resident or distributed in the operating system 608, a program 612, or implemented with special purpose memory and processors. Computer 602 may also implement a compiler 614 that allows a program 612 (e.g., code) written in a programming language to be translated into processor 604 readable code. After completion, program 612 may access and manipulate data stored in memory 606 of computer 602 using the relationships and logic that are generated using compiler 614.

Further, operating system 608 and program 612 may include instructions that, when read and executed by computer 602, may cause computer 602 to perform the steps necessary to implement and/or use various embodiments of the disclosure. Program 612 and/or operating instructions may also be tangibly embodied in memory 606 and/or data communications devices, thereby making a computer program product or article of manufacture according to an embodiment of the present disclosure. As such, the term “program” as used herein is intended to encompass a computer program accessible from any computer readable device or media. Program 612 may exist on an electronic device (e.g., electronic device 113; see FIG. 1), a server (e.g., server 116 of FIG. 1 or cloud device 312 of FIG. 3), a unit (e.g., mobile unit 402; see FIG. 4), and/or another device. Furthermore, portions of program 612 may be distributed such that some of program 612 may be included on a computer readable media within an electronic device (e.g., electronic device 113), some of program 612 may be included on a computer readable media on a server (e.g., server 116 and/or cloud device 312), some of program 612 may be included on a computer readable media on a surveillance unit (e.g., unit 102, unit 402, unit 502), and/or some of program 612 may be included on a computer readable media on another device. For example, with reference to FIG. 1, in some embodiments, program 612 may be configured to run on electronic device 113, server 116, unit 102, another computing device, or any combination thereof. As a specific example, program 612 may exist on server 116 and/or unit 102 and may be accessible to a user via electronic device 113.

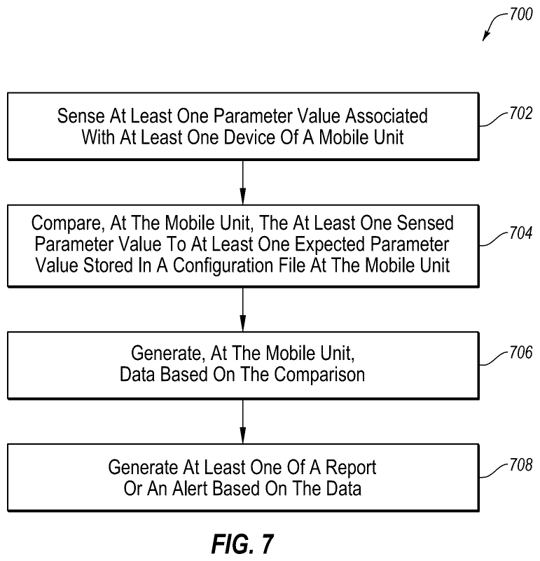

FIG. 7 is a flowchart of an example method 700 of operating a mobile surveillance unit. Method 700 may be arranged in accordance with at least one embodiment described in the disclosure. Method 700 may be performed, in some embodiments, by a device or system, such as system 100 (see FIG. 1), system 300 (FIG. 3), system 400 (see FIG. 4), system 500 (see FIG. 5), system 600 (see FIG. 6), or another device or system. Although illustrated as discrete blocks, various blocks may be divided into additional blocks, combined into fewer blocks, or eliminated, depending on the desired implementation.

Method 700 may begin at block 702, wherein at least one parameter value associated with at least one device of a mobile unit is sensed, and method 700 may proceed to block 704. For example, at least one of a voltage value, current value, and/or temperature value associated with a device (e.g., charger, sensor, power generator, battery, or any other device) of the mobile unit may be sensed. For example, a service, a driver, and/or any suitable sensor (e.g., service 302, driver 304A, and/or driver 304B) may sense the at least one parameter value. In some examples, an application, such as monitoring system 306 (see FIG. 3), may be used to record the at least one parameter value. As noted herein, a parameter may be sensed and evaluated based on another parameter, which may define how often certain parameters are tested.

At block 704, the at least one sensed parameter value may be compared, at the mobile unit, to at least one expected parameter value stored in a configuration file, which is stored at the mobile unit, and method 700 may proceed to block 706. For example, the configuration file may identify one or more expected voltage values, current values, temperature values, etc., of the device (e.g., ideal values or a range of values). For example, health monitor 308 (see FIG. 3) may compare the at least one sensed parameter to one or more expected parameters (e.g., identified in a configuration file).

At block 706, data may be generated based on the comparison, and method 700 may proceed to block 708. For example, the data may be generated via tools 318A, 318B, 318C, and or broker 310 (see FIG. 3).

At block 708, at least one of a report or an alert may be generated based on the data. For example, an alert may result in a ticket (or other event) and an alert and/or a report may be stored (e.g., in storage 314 of FIG. 3) (e.g., after being sent from the mobile unit to cloud device 312).

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 700 may include one or more acts wherein the at least one of the report or the alert may be conveyed from the mobile unit to a remote server (e.g., cloud server, such as server 116 of FIG. 1 and/or cloud device 312 of FIG. 3). As another example, method 700 may include one or more acts wherein at least one parameter value of the number of expected parameter values of the configuration file is updated (e.g., responsive to a command from a remote device).

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used hercin, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system including a number of mobile surveillance units, comprising:
a mobile surveillance unit comprising:
a number of devices;
a number of configuration files, each configuration file including a number of expected parameter values associated with one or more of the number of devices; and
a health monitor unit configured to compare at least one parameter value of the number of parameter values for at least one device of the number of devices to at least one sensed parameter value of the at least one device;
wherein the mobile surveillance unit is configured to generate at least one of a report or an alert responsive to the comparison.

2. The system of claim 1, the mobile surveillance unit further comprising a monitoring device for conveying the at least one sensed parameter value to the health monitor unit.

3. The system of claim 2, the mobile surveillance unit further comprising at least one of a service or a driver for providing the at least one sensed parameter to the monitoring device.

4. The system of claim 1, further comprising a cloud server communicatively coupled to the mobile surveillance unit.

5. The system of claim 1, wherein the health monitor unit is configured to output data based on the comparison.

6. The system of claim 5, further comprising a broker coupled to the health monitor unit and configured to receive the data and generate at least one of a report or an alert based on the data.

7. The system of claim 6, wherein the broker comprises a message queuing telemetry transport (MQTT) broker coupled to the health monitor unit.

8. The system of claim 6, wherein the mobile surveillance unit is configured to convey the at least one of the report or the alert to a remote server via a metered connection.

9. The system of claim 1, wherein the health monitor unit is configured to:
generate a report responsive to the at least one sensed parameter value substantially matching an associated expected parameter value of the number of expected parameter values; and
generate an alert responsive to the at least one sensed parameter value not substantially matching the associated expected parameter value of the number of expected parameter values.

10. A method of operating a mobile surveillance unit, comprising:
sensing at least one parameter value associated with at least one device of a mobile surveillance unit;
comparing, at the mobile surveillance unit, the at least one parameter vale to at least one expected parameter value stored in a configuration file at the mobile surveillance unit;
generating, at the mobile surveillance unit, data based on the comparison; and
generating at least one of a report or an alert based on the data.

11. The method of claim 10, further comprising conveying the at least one of the report or the alert from the mobile surveillance unit to a remote server via a metered connection.

12. The method of claim 10, further comprising updating at least one parameter of the number of expected parameters of the configuration file.

13. The method of claim 10, wherein sensing comprises at least one of sensing at least one of a voltage, a current, a temperature, or a state associated with the at least one device.

14. A mobile surveillance unit, comprising:
a number of electronic devices;
a monitoring unit configured to receive sensed parameter values associated with one or more of the number of electronic devices;
a number of configuration files including a number of parameter values for the number of electronic devices; and
an application program configured to:
compare at least one parameter value of the number of parameter values for at least one electronic device of the number of electronic devices to at least one sensed parameter value of the at least one electronic device; and
generate data based on the comparison.

15. The mobile surveillance unit of claim 14, further comprising a message broker configured to:
receive a message including the data; and
generate at least one of a report or an alert based on the data.

16. The mobile surveillance unit of claim 14, further comprising at least of a driver, a service, or a sensor configured to sense the parameter values.

17. The mobile surveillance unit of claim 14, wherein the number of electronic devices comprises at least one of a camera, a battery, a power generator, a fuel cell generator, a charge controller, or an input/output (I/O) device.

18. The mobile surveillance unit of claim 14, wherein the number of parameter values comprises at least one of a voltage, a current, or a temperature.

19. The mobile surveillance unit of claim 14, wherein the data comprises one or more of a report or an alert.

20. The mobile surveillance unit of claim 14, wherein the mobile surveillance unit is configured to transmit the data to a device via a metered connection.
